(19) United States
(12) Patent Application Publication
(10) Pub. No.: US 2005/0126006 A1
(43) Pub. Date: Jun. 16, 2005

(54) Method for controlling the disc ejecting operation in an optecal disc drive

(76) Inventors: Tsung-Jung Kuo, Hsinchu (TW); Jui-Chiang Lin, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/005,793

(22) Filed: Dec. 7, 2004

(30) Foreign Application Priority Data
Dec. 12, 2003 (TW) 92135167

(51) Int. Cl. G11B 17/03

(52) U.S. Cl. 30/27

(57) ABSTRACT

A method for controlling the disc ejecting operation in an optical disc drive by utilizing a logical element for receiving a state of a switch to drive a roller to load or eject the optical disc is disclosed in this invention. The method comprising the steps that to perform an ejecting operation when the logical element receives an eject command and to selectively perform an additional ejecting operation according to the changing of OFF/ON states of the switch. The additional ejecting operation is for ejecting the disc further after the disc ejecting operation. The additional ejecting operation can be driving the roller for a predetermined period of time or a predetermined number of revolutions to further eject the disc. The additional ejecting operation can also be driving the roller to eject the disc until the switch is at OFF state, and a maximum period of time or a maximum number of revolutions is set to constrain the additional ejecting operation.

### BACKGROUND OF THE INVENTION

1. Field of the Invention

The present invention relates to optical disc drives, and more particularly, to an apparatus and a method for controlling the disc ejecting operation in an optical disc drive.

2. Description of the Related Art

With the developments of information technology and the widespread utilization of multimedia contents, the demanding for data storage solutions with high capacities and low costs raises day by day. Among all the data storage solutions, the optical discs are becoming more and more important for backing up data and exchanging information due to many advantages that the optical storage media have that includes a high data capacity, portability, and a long lifetime for preserving information. Currently, the optical disc drives are widely used such in desktop computers, laptop computers, DVD players, and some instruments or electronic products with built-in microprocessors.

Generally speaking, an optical disc drive loads or ejects an optical disc by utilizing a disc loading mechanism of the optical disc drive. After loading the optical disc into the optical disc drive, the optical disc is fixed to a turntable of a spindle motor for further data access. Besides the conventional tray loading mechanism, the slot loading mechanism is getting more and more popular for its convenience. It is quite handy for users to just insert a disc slightly into the loading/ejecting slot, and then the slot loading mechanism of the optical disc drive takes over the following loading process. Moreover, while loading or ejecting a disc with the slot loading mechanism, the slot loading mechanism can hold the disc firmly throughout all the loading or ejecting process. Thus it makes the slot loading mechanism especially suitable for using in a moving or vibrating environment such as car-use CD audio players and databases for GPS navigators.

Please refer to FIG. 1. FIG. 1 is a top view for illustrating the optical disc drive with slot loading mechanism of the prior art when a 12 cm disc 120 has been ejected from the optical disc drive. For controlling the disc ejecting operation, a prior art optical disc drive 100 has a front panel 102, a roller 104, a gear set 106, an ejecting button 114, and a sensor 112. The sensor 112 is designed for detecting if a disc passing the sensing position and can be used to decide when to stop the roller 104 during the ejecting operation. A logical element (Not Shown) of the disc drive 100 controls a motor (Not Shown) to drive the roller 104 via the gear set 106 to perform a disc ejecting operation and to stop the disc ejecting operation according to the output of the sensor 112. Furthermore, the ejecting button 114 is a push-button switch including a released state and a pressed state that generate an output of open-circuit signal and close-circuit signal (or OFF and ON states), respectively. The ejecting button 114 is usually disposed on the panel 102 of a disc drive 100 for users to give commands such as an ejecting command or others via the ejecting button 114. Besides, there is a round contours in FIG. 1 for showing the positions of a regular sized disc with 12 cm diameter 120. When the logical element receives an eject command to eject a disc inside the optical disc drive, the logical element gives instructions to drive the roller 104 for conveying the disc out of the drive 100 until the sensor 112 no longer being blocked by the disc. The eject command can be triggered by the pressing of the ejecting button 114. Moreover, some components are not described in detail for the sake of not to unnecessarily obscure the description of the present invention.

The sensor 112 can be an electronic switch that includes leaf springs or rods with a HIGH level and a LOW level logical states for indicating whether a disc has been detected. And in the preferred embodiment, the sensor 112 is an optical sensor with an emitter and a receiver to emit and receive a light beam, respectively. For example, when a disc is passing an optical sensor, the light beam from the emitter is blocked by the disc and the sensor has an out put at the LOW level. On the other hand, when the sensor is not blocked by the disc, the sensor has an out put at the HIGH level. Of course the output levels of a sensor can be easily redesigned to have a HIGH level output when the sensor is blocked, and to have a LOW level output when the sensor is not blocked. Furthermore, the logical element for managing the ejecting operation can be a hard-wired logic circuitry or a microprocessor executing a firmware. And in some embodiments, the logical element can even share the same PCB with the sensor 112.

Please refer to FIG. 2. FIG. 2 is a top view for illustrating the optical disc drive with slot loading mechanism of the prior art when an 8 cm disc 130 has been ejected from the optical disc drive. There is a round contours in FIG. 2 for showing the positions of another regular sized disc with 8 cm diameter 130. Moreover, FIG. 3 is a flow chart illustrating the method for controlling the disc ejecting operation for either an 8 cm disc 130 or a 12 cm disc 120 in an optical disc drive with slot loading mechanism of the prior. Referring to both FIG. 1 and FIG. 2, once the logical element receives an eject command (in step 302), the logical element gives instructions to drive the roller 104 to perform an ejecting operation until the sensor 112 is unblocked (Step 304). If the logical element detects that the ejecting button 114 is pressed (Step 306), the progress moves into step 308 and the logical element will drive the roller to perform a loading operation.

For keeping the surface of an optical disc clean to protect the information recorded on the disc, users usually handle an optical disc by only holding the rim or the central hole of an optical disc. Comparing FIG. 1 and FIG. 2, thus when a 12 cm disc 120 is used, it won't bother users a lot for users can easily handle the 12 cm disc 120 since most of the 12 cm disc 120 is exposed outside the optical disc drive 100. However, if an 8 cm disc 130 is used, most of the 8 cm disc 130 is still inside the optical disc drive 100. This could cause a lot of trouble for users to handle or remove the 8 cm disc 130.

Therefore, an method for controlling the disc ejecting operation in an optical disc drive as mentioned above leaves most of the 8 cm disc 130 inside the optical disc drive 100 and cause a lot of trouble for users to handle or remove the 8 cm disc 130. It could also increase the opportunity for users to touch or contaminate the surface of the 8 cm disc 130.

### SUMMARY OF THE INVENTION

Accordingly, it is an object of the present invention to provide a method for controlling the disc ejecting operation in an optical disc drive by utilizing a logical element for receiving a state of a switch to drive a roller to load or eject the optical disc. The method comprising the steps that to perform an ejecting operation when the logical element receives an eject command and to selectively perform an additional ejecting operation according to the changing of OFF/ON states of the switch. The additional ejecting operation is for ejecting the disc further after the disc ejecting operation.

Furthermore, in one embodiment of the present invention, the switch is a push-button switch including a released state and a pressed state that generate OFF and ON states, respectively. The method further comprises a step to perform the additional ejecting operation when the switch is at ON state longer than a predetermined time period or the switch is at ON state more than a predetermined number of times during a predetermined waiting period. The additional ejecting operation can be driving the roller for a predetermined period of time or a predetermined number of revolutions to further eject the disc. The additional ejecting operation can also be driving the roller to eject the disc until the switch is at OFF state, and a maximum period of time or a maximum number of revolutions is set to constrain the additional ejecting operation.

It is another object of the present invention to provide a method for controlling the disc ejecting operation in an optical disc drive by changing a released and a pressed states of an ejecting button to control a roller to eject an optical disc. The method comprises steps to perform an ejecting operation when the ejecting button is changed from the released state to the pressed state and to selectively perform an additional ejecting operation according to the changing of the released and the pressed states of the ejecting button.

It is yet another object of the present invention to provide a method for controlling the disc ejecting operation in an optical disc drive by utilizing a logical element to drive a roller to eject an optical disc. The method comprises steps to perform an ejecting operation when the logical element receives an eject command and to perform an additional ejecting operation when the optical disc is an 8 cm disc.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view for illustrating the optical disc drive with slot loading mechanism of the prior art when a 12 cm disc has been ejected from the optical disc drive.

FIG. 2 is a top view for illustrating the optical disc drive with slot loading mechanism of the prior art when an 8 cm disc has been ejected from the optical disc drive.

FIG. 3 is a flow chart illustrating the method for controlling the disc ejecting operation for either an 8 cm disc or a 12 cm disc in an optical disc drive with slot loading mechanism of the prior.

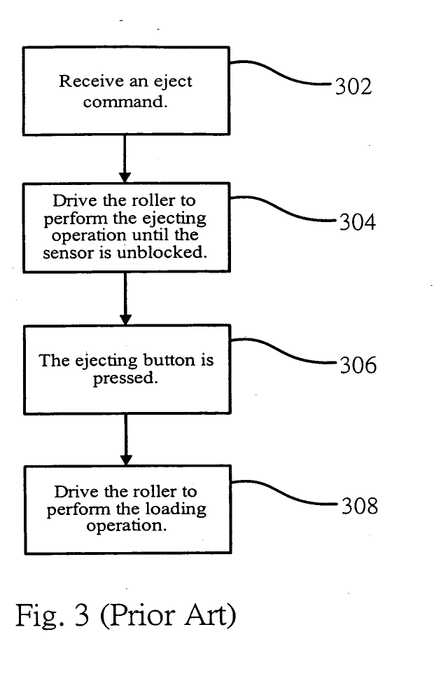

FIG. 4 is a flow chart illustrating one embodiment of the method for controlling the disc ejecting operation in an optical disc drive with slot loading mechanism according to the present invention.

FIG. 5 FIG. 5 is a flow chart illustrating another embodiment of the method for controlling the disc ejecting operation in an optical disc drive with slot loading mechanism according to the present invention.

FIG. 6 is a top view for illustrating the optical disc drive when a 12 cm disc has been ejected with the additional ejecting operation performed according to the present invention.

FIG. 7 is a top view for illustrating the optical disc drive when an 8 cm disc has been ejected with the additional ejecting operation performed according to the present invention.

FIG. 8 is a top view for illustrating the relation between various elements in an optical disc drive with slot loading mechanism after a disc has been loaded.

### DESCRIPTION OF THE EMBODIMENTS

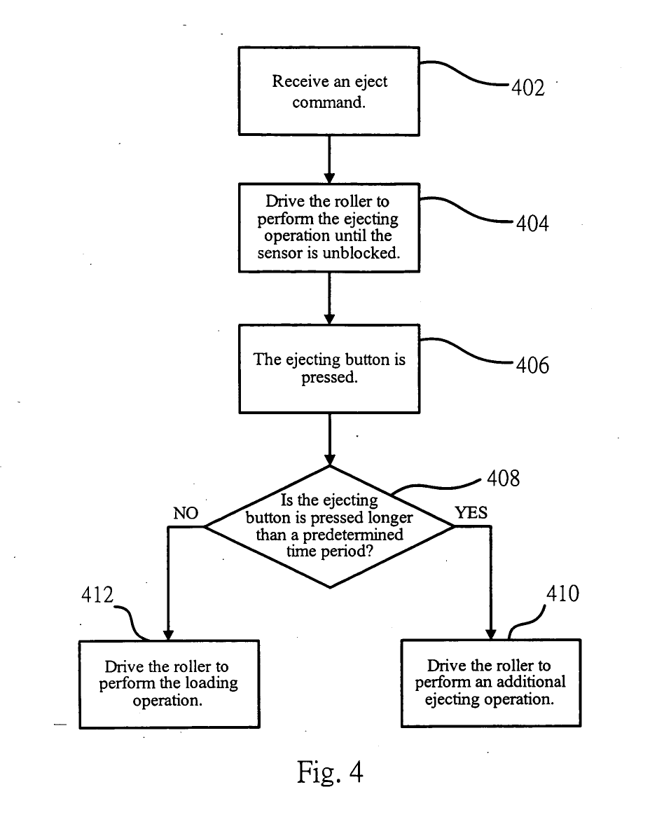

Please refer to FIG. 4. FIG. 4 is a flow chart illustrating one embodiment of the method for controlling the disc ejecting operation in an optical disc drive with slot loading mechanism according to the present invention. Once the logical element receives an eject command (in step 402), the logical element gives instructions to drive the roller 104 to perform an ejecting operation until the sensor 112 is unblocked (Step 404). If the logical element detects that the ejecting button 114 is pressed (Step 406), the progress moves into step 408 and the logical element determines whether the ejecting button 114 is pressed longer than a predetermined time period or not. If the ejecting button 114 is pressed longer than the predetermined time period, the progress moves to step 410 to perform an additional ejecting operation. On the other hand, if the ejecting button 114 is not pressed longer than the predetermined time period, the progress moves to step 412 to perform a disc loading operation.

The additional ejecting operation is for ejecting the disc further after the disc ejecting operation to allow most of the disc (120 or 130) being outside of the optical disc drive 100. The additional ejecting operation can be driving the roller 104 for a predetermined period of time or a predetermined number of revolutions to further eject the disc. In an embodiment according to the present invention, the predetermined period of time or the predetermined number of revolutions are set such that the central hole of the 8 cm disc 130 can be outside of the disc drive 100 thoroughly. Moreover, the additional ejecting operation can also be driving the roller 104 to eject the disc until the ejecting button 114 is released. And a maximum period of time or number of revolutions can be set to constrain the additional ejecting operation.

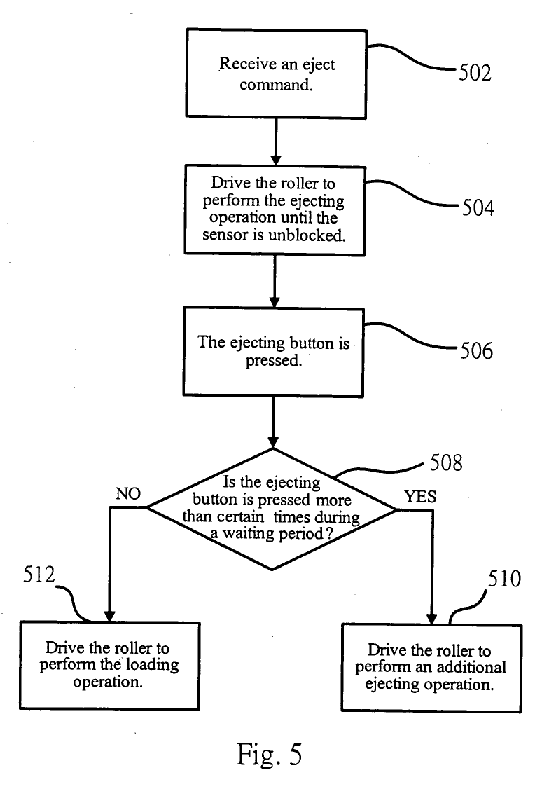

Please refer to FIG. 5. FIG. 5 is a flow chart illustrating another embodiment of the method for controlling the disc ejecting operation in an optical disc drive with slot loading mechanism according to the present invention. Once the logical element receives an eject command (in step 502), the logical element gives instructions to drive the roller 104 to perform an ejecting operation until the sensor 112 is unblocked (Step 504). If the logical element detects that the ejecting button 114 is pressed (Step 506), the progress moves into step 508 and the logical element determines whether the ejecting button 114 is pressed more than a predetermined number of times during a predetermined waiting period. If the ejecting button 114 is pressed more than the predetermined number of times, the progress moves to step 510 to perform an additional ejecting operation. On the other hand, if the ejecting button 114 is not pressed more than the predetermined number of times, the progress moves to step 512 to perform a disc loading operation.

For example, the predetermined number of times can be 2 times, and the predetermined waiting period can be 1 second. Thus in step 508, it monitors if the ejecting button 114 is pressed more than twice within 1 second.

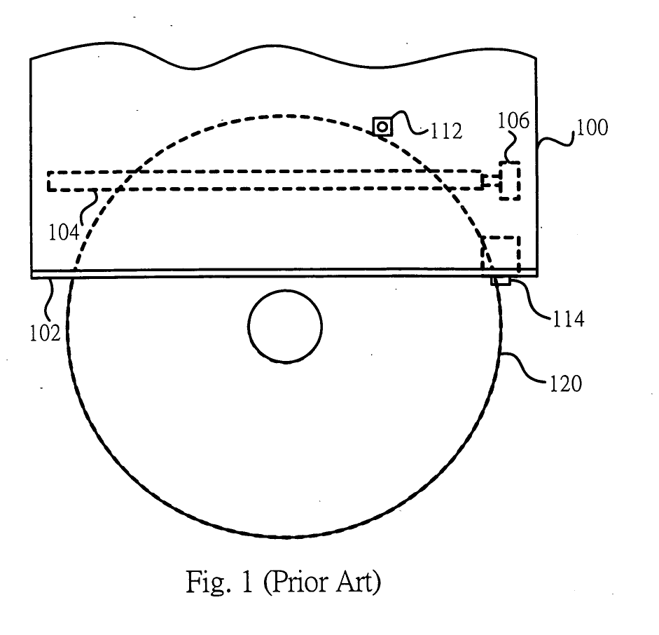

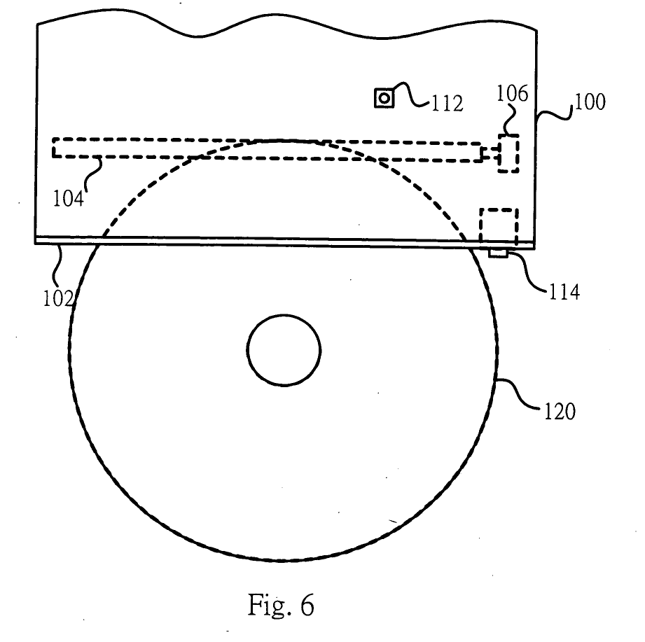

Now compare FIG. 1 and FIG. 6. FIG. 6 is a top view for illustrating the optical disc drive when a 12 cm disc 120 has been ejected with the additional ejecting operation performed according to the present invention. One skilled in the art can find that when a 12 cm disc 120 is used, almost the whole disc can be ejected outside the disc drive 100 after performing the additional ejecting operation according to the present invention. This can increase the convenience for users to remove the ejected disc.

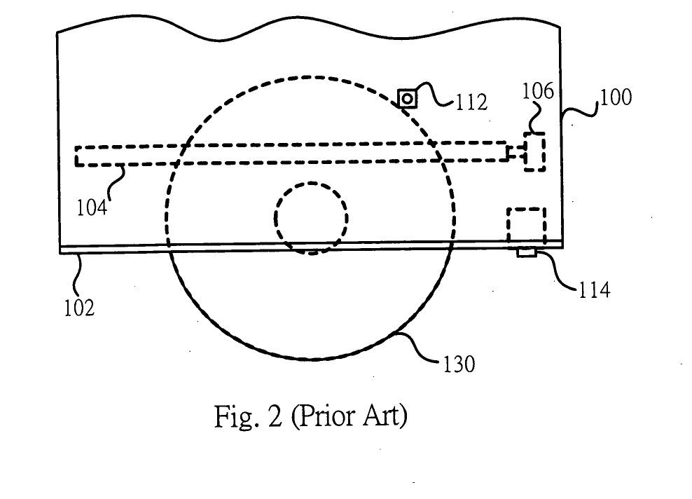

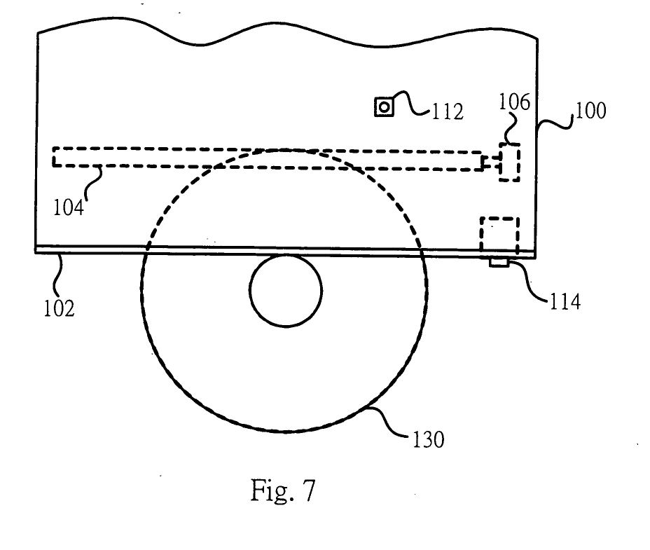

Now further compare FIG. 2 and FIG. 7. FIG. 7 is a top view for illustrating the optical disc drive when an 8 cm disc 130 has been ejected with the additional ejecting operation performed according to the present invention. One skilled in the art can find that when an 8 cm disc 130 is used, most of the whole disc now can be ejected outside the disc drive 100 after performing the additional ejecting operation according to the present invention. Especially with setting the parameters carefully to allow the central hole of the 8 cm disc 130 outside the disc drive 100, it can readily increase the convenience for users to remove the ejected disc even further.

Although the ejecting button 114 disposed on the panel 102 is used to control whether the additional ejecting operation is performed according to the preferred embodiments, a designated switch can also be used to control the additional ejecting operation according to the teaching in FIG. 4 and FIG. 5 by monitoring the changing of its OFF/ON states. The designated switch can be a switch disposed on the panel 102 or an external switch connecting to the disc drive 100.

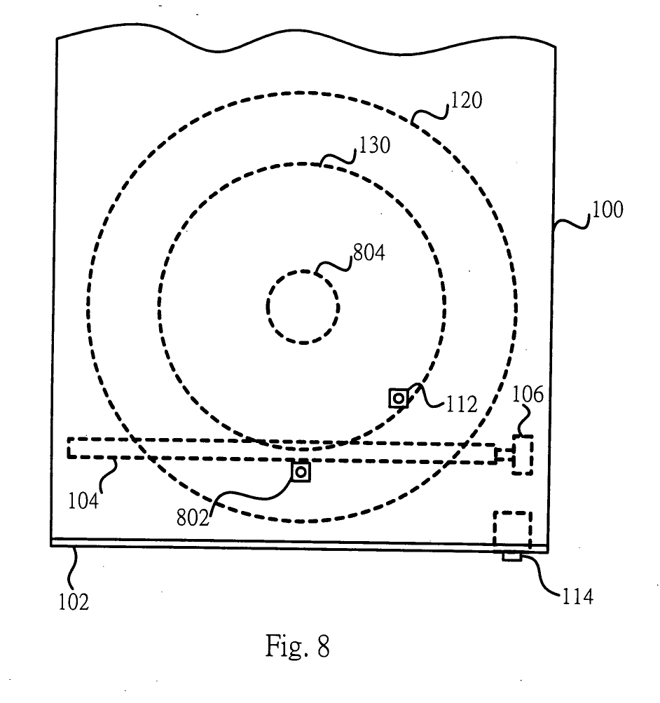

Besides, if the 8 cm disc 130 is used, the disc drive 100 may perform the additional ejecting operation automatically without monitoring the ejecting button 114. Referring to FIG. 8, FIG. 8 is a top view for illustrating the relation between various elements in an optical disc drive with slot loading mechanism after a disc has been loaded. In this figure, it further discloses a loading sensor 802 and a turntable 804 of a spindle motor in the optical disc drive 100. Once the disc is loaded and fixed on the turntable 804, the disc drive 100 can detect the size of the loaded disc by reading the disc information recorded on the disc or by checking the status of the sensor 112 and the loading sensor 802.

While the present invention has been particularly shown and described with reference to a preferred embodiment, it will be understood by those skilled in the art that various changes in form and detail may be without departing from the spirit and scope of the present invention.

1. A method for controlling the disc ejecting operation in an optical disc drive by utilizing a logical element for receiving a state of a switch to drive a roller to load or eject the optical disc, the method comprising:
performing an ejecting operation when the logical element receives an eject command; and
selectively performing an additional ejecting operation according to the changing of OFF/ON states of the switch;
wherein the additional ejecting operation is for ejecting the disc further after the disc ejecting operation.

2. The method for controlling the disc ejecting operation in an optical disc drive according to claim 1, wherein the switch is a push-button switch including a released state and a pressed state that generate OFF and ON states, respectively.

3. The method for controlling the disc ejecting operation in an optical disc drive according to claim 1, wherein the method further comprising:
performing the additional ejecting operation when the switch is at ON state longer than a predetermined time period.

4. The method for controlling the disc ejecting operation in an optical disc drive according to claim 1, wherein the method further comprising:
performing the additional ejecting operation when the switch is at ON state more than a predetermined number of times during a predetermined waiting period.

5. The method for controlling the disc ejecting operation in an optical disc drive according to claim 1, wherein the additional ejecting operation comprising:
driving the roller for a predetermined period of time to further eject the disc.

6. The method for controlling the disc ejecting operation in an optical disc drive according to claim 1, wherein the additional ejecting operation comprising:
driving the roller for a predetermined number of revolutions to further eject the disc.

7. The method for controlling the disc ejecting operation in an optical disc drive according to claim 1, wherein the additional ejecting operation comprising:
driving the roller to eject the disc until the switch is at OFF state, and a maximum period of time is set to constrain the additional ejecting operation.

8. The method for controlling the disc ejecting operation in an optical disc drive according to claim 1, wherein the additional ejecting operation comprising:
driving the roller to eject the disc until the switch is at OFF state, and a maximum number of revolutions is set to constrain the additional ejecting operation.

9. A method for controlling the disc ejecting operation in an optical disc drive by changing a released and a pressed states of an ejecting button to control a roller to eject an optical disc, the method comprising:
performing an ejecting operation when the ejecting button is changed from the released state to the pressed state; and
selectively performing an additional ejecting operation according to the changing of the released and the pressed states of the ejecting button
wherein the additional ejecting operation is for ejecting the disc further after the disc ejecting operation.

10. The method for controlling the disc ejecting operation in an optical disc drive according to claim 9, wherein the method further comprising:
performing the additional ejecting operation when the ejecting operation is pressed longer than a predetermined time period.

11. The method for controlling the disc ejecting operation in an optical disc drive according to claim 9, wherein the method further comprising:
performing the additional ejecting operation when the ejecting operation is pressed more than a predetermined number of times during a predetermined waiting period.

12. The method for controlling the disc ejecting operation in an optical disc drive according to claim 9, wherein the additional ejecting operation comprising:
driving the roller for a predetermined period of time to further eject the disc.

13. The method for controlling the disc ejecting operation in an optical disc drive according to claim 9, wherein the additional ejecting operation comprising:
driving the roller for a predetermined number of revolutions to further eject the disc.

14. The method for controlling the disc ejecting operation in an optical disc drive according to claim 9, wherein the additional ejecting operation comprising:
driving the roller to eject the disc until the ejecting operation is released, and a maximum period of time is set to constrain the additional ejecting operation.

15. The method for controlling the disc ejecting operation in an optical disc drive according to claim 9, wherein the additional ejecting operation comprising:
driving the roller to eject the disc until the ejecting operation is released, and a maximum number of revolutions is set to constrain the additional ejecting operation.

16. A method for controlling the disc ejecting operation in an optical disc drive by utilizing a logical element to drive a roller to eject an optical disc, the method comprising:
performing an ejecting operation when the logical element receives an eject command; and
performing an additional ejecting operation when the optical disc is an 8 cm disc; wherein the additional ejecting operation is for ejecting the disc further after the disc ejecting operation.

17. The method for controlling the disc ejecting operation in an optical disc drive according to claim 16, wherein the additional ejecting operation comprising:
driving the roller for a predetermined period of time to further eject the disc.

18. The method for controlling the disc ejecting operation in an optical disc drive according to claim 16, wherein the additional ejecting operation comprising:
driving the roller for a predetermined number of revolutions to further eject the disc.
